(19) United States
(12) Patent Application Publication
(10) Pub. No.: US 2007/0125838 A1
(43) Pub. Date: Jun. 7, 2007

(54) Electronic wallet management

(76) Inventors: Eric Chun Wah Law, San Jose, CA (US); Lap Man Yam, Los Altos Hills, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/377,027

(22) Filed: Mar. 15, 2006

Related U.S. Application Data
(60) Provisional application No. 60/748,061, filed on Dec. 6, 2005.

(51) Int. Cl. G07F 19/00; G06Q 40/00; G06Q 99/00

(52) U.S. Cl. 235/379; 705/44; 705/65

(57) ABSTRACT

A system (and a method) for electronic financial transactions includes at least of each of a sender having an electronic wallet, a recipient having an electronic wallet, a sending bank having a host application system and an authentication server, a receiving bank having a host application system and an authentication server, and a wallet management center with a host application system and an authentication server. The sender uses its electronic wallet to send an encrypted payment instruction directly to the electronic wallet of the recipient. The recipient can accept the payment by performing a second level encryption of the payment instruction for submission to the wallet management center for authentication. Once authenticated, the wallet management center immediately notifies the recipient and submits payment instructions for clearing by the corresponding sending and receiving banks. Payment authorization is authenticated directly by the sending bank without involvement of the wallet management center.

### CROSS REFERENCE TO RELATED APPLICATIONS

This application claims the benefit of U.S. Provisional Application No. 60/748,061, filed Dec. 6, 2005, which is incorporated by reference in its entirety.

This application is related to U.S. patent application Ser. No. ______, filed Mar. 15, 2006, titled “Single One-Time Password Token with Single PIN For Access To Multiple Providers”, which claims the benefit of U.S. Provisional Application No. 60/748,061, filed Dec. 6, 2005, and titled “Single One-Time Password Token with Single PIN For Access To Multiple Providers”, the contents of each is incorporated by reference in its entirety.

### BACKGROUND

1. Field of Art

The present invention generally relates to the field of electronic payment transactions, and more specifically, to direct electronic payment transactions between parties, for example, a consumer and a merchant.

2. Description of the Related Art

With the proliferation of the World Wide Web (WWW), online electronic commerce (e-commerce) has flourished. As in the traditional “brick and mortar” physical commerce environments, in this e-commerce environment, credit cards are a dominant payment method. Banks and other financial institutions that issue credit cards do absorb credit and collection risks in such transactions, but often offset these risks with retail transaction fees and consumer payment and interest fees.

In the brick and mortar physical commerce environment, a consumer could decide whether it is safe and appropriate to use a credit card and a merchant could verify additional identity proof of the consumer (such as picture identification (“ID”)) before conducting a transaction. For example, consumers are willing to use a credit card with reputable and honest merchants. Similarly, merchants are willing to accept credit cards without additional identity proof when it appears consumers have money to pay for goods or services. In some instances, merchants do not even verify signatures on credit card transaction vouchers. Moreover, for smaller transactions, such as car parks and toll gates, merchants often bypass real-time online credit card authorization altogether.

In general, because the conventional credit card system is grounded on a trust foundation, it is susceptible to abuse and fraud. Fraudulent transactions occur in both the physical and the online commerce environments. Due to anonymity in the online environment, it is much more difficult for the consumers to verify the authenticity of the merchants and vice versa. Accordingly, many consumers hesitate or outright refuse to enter credit card numbers online. Moreover, spoofing of web sites has led even more online consumers from refusing to provide credit card numbers for fear that they may have contacted a fake web site. Very few consumers have the technical expertise to inspect a SSL certificate and to verify its authenticity.

To address the concerns of consumers, credit card issuing companies have implemented additional security measures for their credit cards. Examples include user ID and password validation by the card issuing banks (e.g., the “Verified by Visa” initiative by Visa U.S.A. (San Francisco, Calif.) and one-time single-use credit card numbers). These measures have limited success because of technical complexity and generally lower level of usability. In addition, because static passwords and the magnetic stripe based cards are inherently insecure, credit card companies advocate the use of smart cards that have built-in microprocessors and memory and that can perform mutual authentication with the connecting devices when the cards are used (e.g., the Europay, MasterCard and Visa (EMV) initiative). In addition to replacing existing magnetic stripe cards with new smart cards, these new system require worldwide systems infrastructure upgrade and a massive replacement of all card-accepting devices to equip with smart card readers (e.g., point-of-sale terminals and card authorization devices). In sum, this undertaking will take considerable time and money, while not eliminating security vulnerabilities of the conventional credit card system remain in the interim when cards and card-accepting devices are upgraded.

Despite efforts of credit card companies to provide greater credit card security, alternative online payment methods have emerged in recent years to capture the ever-growing and substantial online payment market. A first type of alternative payment methods is a financial intermediary that uses email or other online messaging to notify the payees when money is received from the payers. An example of such a commercial implementation is PayPal®, an eBay company (San Jose, Calif.). In this configuration, a member registers their credit cards and/or bank accounts with the financial intermediary. When the member (payer) sends money, one logs on to the financial intermediary and instructs the system to send a notification email (or other online message) to another member that can be a merchant (payee). Money is funded from a credit card or a bank account of the payer. Received money is escrowed in the system for the payee who may later transfer the money back to a credit card or a bank account.

While this first alternative payment method offers privacy (hiding credit card and bank account numbers from payees) and convenience (email notification), it offers a lower level of security. Outgoing emails are subject to ‘phishing’ attacks. In such attacks a hacker sends a fake email pretending to have originated from the financial intermediary. A response to the email (or clicking on a link within) redirects the recipient to a fake web site resembling that of the financial intermediary. This site asks the recipient to supply user ID and password to sign on. Once entered by user, the hacker harvests the information and can later use it to sign on to the recipient's real account at the financial intermediary to steal money. In addition, because credit cards are used as funding source for online payment, the financial intermediary cannot eliminate the transaction cost of the credit cards. This results in a higher total cost than traditional credit card transactions. Further, money liquidity is reduced because the financial intermediary acts as a money escrow for the received money of the payees (e.g. merchants).

A second type of alternative payment methods is an electronic check system that is an extension of the paper check system. Electronic checks come in various forms from digitizing paper checks to provisioning of true electronic checks. Examples of commercial implementations are TeleCheck by TeleCheck Services, Inc. (Houston, Tex.) and i-Check by ITI Internet Services, Inc. (Tacoma, Wash.). For example, a paper check can be scanned and read by a special point of sales terminal that converts the paper check into an electronic form for authorization by the payer bank. The paper check is then stamped ‘void.’

In another variation, instead of a special point of sales terminal, the online system may display a web form for the consumer to enter and the input fields are exactly the same as the paper check. The check number, bank routing code and bank account number are copied from the consumer's paper check manually by the consumer who is responsible to mark the ‘issued’ paper check as used. Check clearing is done by printing the received electronic checks and mailing them to a check clearing house or by sending the electronic file to an automated clearing house. Although the second alternate payment method allows each check number to be used only once and a clearing house is able to reject duplicates, security is still susceptible. For example, in one implementation a customer signature is simply substituted by the entry of the customer name. Being that check numbers are consecutive in nature, it is possible to issue a fake electronic check once the basic check book information is known to the hacker.

In the pure electronic form, an electronic check can be presented instead of a paper check and a digital signature can replace a hand written signature. One example is the electronic check (eCheck) initiative by the Financial Services Technology Consortium. Such electronic check systems rely on public key infrastructure and tamper resistant devices such as smart cards to function as a container of electronic checkbook and an electronic stamp. Although technically viable, dependency on a public key infrastructure, heavy infrastructure requirements of smart card receiving devices, and the use of client side certificates may have constrained mass adoption.

A third type of alternative payment methods is a pre-payment stored-value system. Examples of this method include gift cards and stored-value cards. Typically, a consumer can buy a gift card at a certain monetary value or put money into a stored-value card. The gift card or the stored-value card can then be used in retail environments. Many commercial implementations allow the consumers to add value to their stored-value cards using special add-value machines, point-of-sales terminals or automated direct debits. Examples include the Starbucks Card from Starbucks Corporation (Seattle, Wash.) and the Octopus cards (Hong Kong).

There are many variations of gift cards and stored-value cards. These cards may be paper based, magnetic stripe card or smart card based. The paper-based variation may be used online without special card readers where the user may enter unique numbers from a stored-value card to denote certain fixed amount of payment. Stored-value cards are usually anonymous and they are designed for small amount transaction. Thus, they require simple or no authentication.

A more technically sophisticated form of stored-value system is smart card based electronic cash. Examples of such cards include Visa Cash from Visa U.S.A. (San Francisco, Calif.) and Mondex from MasterCard International Inc. (Purchase, N.Y.). Smart card based electronic cash systems usually enhance security by employing strong authentication for card to card transfer and card to point-of-sales terminal transfer. However, their limitations include the need for special card reading devices or point-of-sales terminals and heavy infrastructure for a central clearing house if the cards are used for more than one organization.

In addition to the shortcomings already mentioned, gift cards, stored-value cards and smart card based electronic cash reduce money liquidity because the money is pre-paid before the actual goods and/or services are purchased. Thus, the pre-payment method is usually restricted to a single organization or a small group of merchants.

Another variation of the stored-value system is a money escrow system where the consumers may deposit money into the escrow account and pay a merchant online by transferring money from one's escrow account to the merchant's escrow account. Again a significant disadvantage is the reduction of money liquidity.

A fourth type of alternative payment method is a utility bill linked transaction system where the consumers may pay merchants using credits from a utility bill. In one variation, the system is operated by a mobile phone operator that allows a merchant to send invoice in the form of a short message service (SMS) to the consumer. When the consumer replies the short message, a payment transaction will occur. The mobile phone operator will pay the merchant for the amount and then collect money from the consumer by indicating the transaction on the phone bill. In another variation, the consumer would dial a telephone number or send a SMS to the merchant and the phone operator can record the transaction. The limitation is usually a constraint in total allowable monthly transaction value.

A fifth type of alternative payment method is a commodity based alternative currency. Users purchase the alternative currency with conventional money like cash or paper checks. The currency can be in a paper form, e.g., a currency note, or in an electronic form, e.g., a user account with password or other authentication means. If the alternative currency is backed by commodity such as precious metal, e.g., gold or silver, the user is actually buying the commodity with conventional money and keeps the commodity in the escrow associated with the alternative currency provider. In one implementation, the alternative currency is presented as weight of a certain precious metal. Some alternative currency providers back up the currency with full value of commodity while others maintain a smaller amount of commodity.

In another variation, the alternative currency is not tied with any commodity. It is linked with a commitment to deliver the same value of goods and services. The latter case has been experimented in localities with an attempt to attract investments and local spending. The limitations of alternative currency are lower security and reduced money liquidity. In many cases, these alternative currencies are not part of the regulated money supply, the Federal Reserves or other national vault. As a result, tracking money flow is more difficult or not possible, especially when the alternative currency is used outside the national boundary.

To address the security vulnerability of the current alternative payment methods, two-factor authentication and public key infrastructure are a viable technical option for enhanced security. However, high costs and technical complexity for implementing such systems deters their widespread deployment.

With the exception of the electronic check and the utility bill linked transaction systems, the current alternative payment methods suffer from reduced money liquidity. Nevertheless, electronic check systems do not guarantee that money is available for transfer because there is no validation of available fund before a check is submitted to the issuing bank of the payer. Utility bill linked transaction systems are constrained too because the credit level is usually set to a relatively low value to minimize credit and collection risks.

With the exception of smart card based electronic cash systems, none of the current alternative payment methods are capable of direct money transfer between the payer and the payee. For the first type (financial intermediary), the intermediary serves as the escrow in performing the payment transaction. For the second type (electronic check), it is possible to directly send the electronic check from the payer to the payee but the payee cannot verify whether the payer has sufficient funds until the check is submitted to the bank of the. payer. For the third type (stored-value system), money is pre-paid before goods or services are purchased. For the fourth type (utility bill linked transaction system), the intermediary offers the credit to the payer. In some implementations, advanced payment of one-month utility bill or more may be required. In the latter case, the intermediary becomes a money escrow. Similarly for the fifth type (commodity based alternative currency), money is pre-paid for commodity before the actual goods or services are purchased and the intermediary keeps the money or commodity in an escrow.

Each presently available alternative payment method is conventional and each has significant limitations. Therefore, there is a need for a system and a payment method that supports direct transaction between the payer and payee with high level of confidence that there are available funds for money transfer at the time of transaction. There is also a need for the system and payment method to be secure without incurring a usability burden. There is also a need for a system and payment method that does not reduce money liquidity and is fully compatible with the existing banking systems.

### SUMMARY

The present invention includes a system and a method for electronic wallet management to allow for a direct payment transaction between a payer and a payee. For ease of discussion, a payer also may be referenced as a sender and a payee also may be referenced as a recipient.

In one embodiment an electronic wallet is configured to provide an extension of the current mainstream banking system. For example, the electronic wallet can be configured as a new banking account, similar to existing banking accounts, such as checking, savings, or credit accounts. In this configuration, the electronic wallet is fully integrated with a mainstream banking system, without constraining present product offerings and differentiation of individual banks. In addition, in some embodiments, the electronic wallet account can be structured as a debit account similar to saving or checking account (interest or non-interest bearing), or as a credit account with a certain pre-approved monthly credit line.

In one embodiment, because the electronic wallet is configured as an extension of present banking instruments, a user has flexibility to transfer money from traditional banking accounts to an electronic wallet account or vice versa. These transfers can be facilitated through existing banking channels such as over-the-counter service, automatic teller machines (ATM), Internet banking services and the like. In addition, such transfer transactions between the electronic wallet accounts and the traditional banking channels may be posted to an electronic wallet management center for record keeping and for synchronization with the electronic wallets of the corresponding users, e.g., the sender (or payer) and the recipient (or payee).

Turning more to a banking example, a sender may open an electronic wallet account with a bank. In response, a wallet management system installs a wallet application in a device. The installed wallet application in the device may be referenced as an “electronic wallet” (or “wallet”). The device with the installed wallet application may be referenced generally as a token (or intelligent token). Examples of devices operable as a token include a personal computer, a mobile phone, a PDA or other portable device.

The electronic wallet includes a token application. The token application includes a token dataset, cryptographic secrets and parameters, and a wallet dataset (or transaction dataset). The token dataset includes one or more compartments, each one corresponding to a bank and an associated account balance for the wallet account with that bank. The wallet dataset includes a wallet master key when first loaded into the device. For simplicity, the term “wallet” may also be used to represent the entire token (i.e., the device with executing wallet application).

As previously noted, in one embodiment, the electronic wallet provides a mechanism for direct payment between a sender (payer) and recipient (payee). For a sender to begin using the electronic wallet for payments, it must first be initialized. Generally the sender should have sufficient balance (e.g., wallet account balance in the bank used by the sender) in the electronic wallet account that is synchronized with and presented by the electronic wallet. When the electronic wallet is first launched (executed), it will authenticate itself with the wallet management center to collect a number of unique key references that are presented as a range of numerical values. The total number of unique key references is pre-configured according to the preference of the individual sender. One key reference is for each payment instruction. Note that when all the key references in the memory of the wallet are consumed, the wallet will reload with new values automatically. Similarly, a recipient would have a similar set up to establish an electronic wallet with information on which account to deposit money (e.g., wallet account used by recipient) received in a transaction.

To send (or transmit) money to another electronic wallet, the sender selects a payment function from a main menu of the electronic wallet. The wallet identifies the next available key reference and derives an encryption key based on the key reference and the wallet master key within the token application. The encryption key is used to encrypt the recipient wallet identification (ID), a payment amount, and an authorization code into a cipher text that formulates the payment instruction. The authorization code is a one-time password or digital signature generated automatically using the token secrets and token parameters for the selected sending bank (i.e., the sender's bank). The electronic wallet of the sender transmits the payment instruction directly to an electronic wallet of the recipient. In one embodiment, the instructions may be sent through an online messaging, for example, short message service (SMS) of a mobile phone network, ‘Contactless’ Near Field Communication (NFC), Bluetooth, or IEEE 802.11 (e.g., WiFi).

The recipient, having a previously or just established wallet account, receives the payment instruction from the token of the sender and reads the payment amount within the payment instruction. If the recipient accepts the payment, the electronic wallet of the recipient will derive an encryption key based on the key reference in the payment instruction and the wallet master key of the recipient token application.

The electronic wallet performs an optional second level encryption of the previously encrypted payment instruction and forwards the two-level encrypted payment instruction to the wallet management center for clearing. In one embodiment, the optional two-level encrypted payment instruction can only be decrypted by the wallet management center. On successful decryption of the two-level encrypted payment instruction, the wallet management center validates the recipient wallet ID by matching the decrypted recipient wallet ID in the payment instruction with the given recipient wallet ID in the caller identification of the incoming message from the recipient. When successfully matched, the wallet management center will advise the recipient that the payment instruction is authentic, i.e., it is originated from the specific sender and received by the specific intended recipient. As described, this process creates a basis for transaction non-repudiation.

It is noted that selection of the recipient wallet ID as a parameter for verification is one illustrative example of an implementation. In alternative embodiments, other value(s) given by the sender may be used as parameter(s) for verification to achieve the same authentication result. For example, another shared secret between the sender and the wallet management center.

The wallet management center is structured to facilitate the transaction, but does not actually take part in the transaction with respect to the sending and receiving of the payment. Therefore, the transaction remains direct between the sender (payer) and recipient (payee). The wallet management center is structured to submit the authentic payment instruction that contains the payment amount and the sender authorization code to the sending bank. The authorization code can only be verified (or authorized) by the sending bank. Once verified, the sending bank debits the wallet account of the sender and transmits a sending bank reference number to the wallet management center.

When the sending back reference number is received, the wallet management center removes the authorization code from the payment instruction and transmits it and the sending bank reference number to the receiving bank. The receiving bank credits the wallet account of the recipient and responds with a receiving bank reference number. When the receiving bank reference number is received, the wallet management center optionally transmits a confirmation message to the sender and the recipient, which automatically updates the account balance on the respective electronic wallets.

There are a number of advantages of the present invention. For example, because the electronic wallet account is part of the mainstream banking system, money is kept within the banking system for the users who have opened electronic wallet accounts. There is no need to transfer the money into another escrow or store the value in pre-paid cards. Thus, the user retains monetary liquidity. Another advantage is trusted direct payment instructions from the sender to the recipient provided a sender has sufficient funds in its electronic wallet. Yet another advantage is authenticity of the payment instruction serving as a proof of transaction non-repudiation.

Still another advantage is robust security. The account balance of an electronic wallet is determined by the available money in the corresponding wallet account in a bank. There are two levels to check the availability of funds for a payment instruction. First, the account balance of the electronic wallet is synchronized with the wallet account in a bank after each transaction or upon user request. The electronic wallet, therefore, can verify if the available balance is sufficient for a particular payment. Second, the current account balance also is maintained by the wallet management center that once more checks the availability of funds once the payment instruction is verified as authentic. Therefore, the risk associated with a pre-determined money balance is minimal. Another advantage is flexibility of use of a direct payment method that can integrate and interoperate with existing and evolving technology, thereby, reducing or eliminating the need for a new transaction infrastructure.

Yet another advantage is the recipient may use a common intelligent token, for example, a personal computer, a mobile phone, a PDA or other portable device, having its electronic wallet from which payment can be accepted. The system is configured to be beneficially flexible to accommodate a wide array of transaction environments. For example, the electronic wallet can be configured within a mobile phone of an individual participating in a one-time transaction, e.g., a garage sale, or of an individual street merchant. Likewise, the system is flexible so that the wallet can be configured within a high performance computing system (e.g., servers) to handling large volume of payment transactions in real time or batch processing modes that large transaction environment (e.g., large retail stores) may deploy.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the following detailed description and the appended claims, when taken in conjunction with the accompanying drawings, in which:

Figure (FIG.) 1 illustrates one embodiment of the logical components of a token with installed wallet application (“wallet ready” token) in accordance with the present invention.

FIG. 2a illustrates one embodiment of an environment overview in which an electronic wallet may operate in accordance with the present invention.

FIG. 2b illustrates another embodiment of an environment overview in which an electronic wallet may operate in accordance with the present invention.

FIG. 3 illustrates one embodiment of an electronic wallet management system in accordance with the present invention.

FIG. 4 illustrates one embodiment of a process for wallet preparation and direct payment from a sender to a recipient in accordance with the present invention.

FIG. 5 illustrates one embodiment of a process for clearing a payment instruction with a sending bank and a receiving bank in accordance with the present invention.

FIG. 6 illustrates one embodiment of a process for synchronizing balances with the wallet management center after crediting or debiting electronic wallet accounts using conventional banking channels in accordance with the present invention.

FIG. 7 illustrates a sample user interface for the sender's wallet in accordance with the present invention.

FIG. 8 illustrates a sample user interface for the recipient's wallet in accordance with the present invention.

FIG. 9 illustrates one example embodiment of a transaction completed using an electronic wallet in accordance with the present invention.

### DETAILED DESCRIPTION

The Figures (FIGS.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles described herein.

Generally, the disclosed embodiments describe a system and a method for creating, managing, and transacting with electronic wallets. Electronics wallets beneficially operate similar to cash in terms of direct payments between a payer and a payee without the need for actual cash on hand. Moreover, because the system and the method can be integrated within established, existing financial systems, it builds on secured and trusted transaction environments and reduces or eliminates the need for creating complex infrastructure to handle transactions within it.

Wallet Application Overview

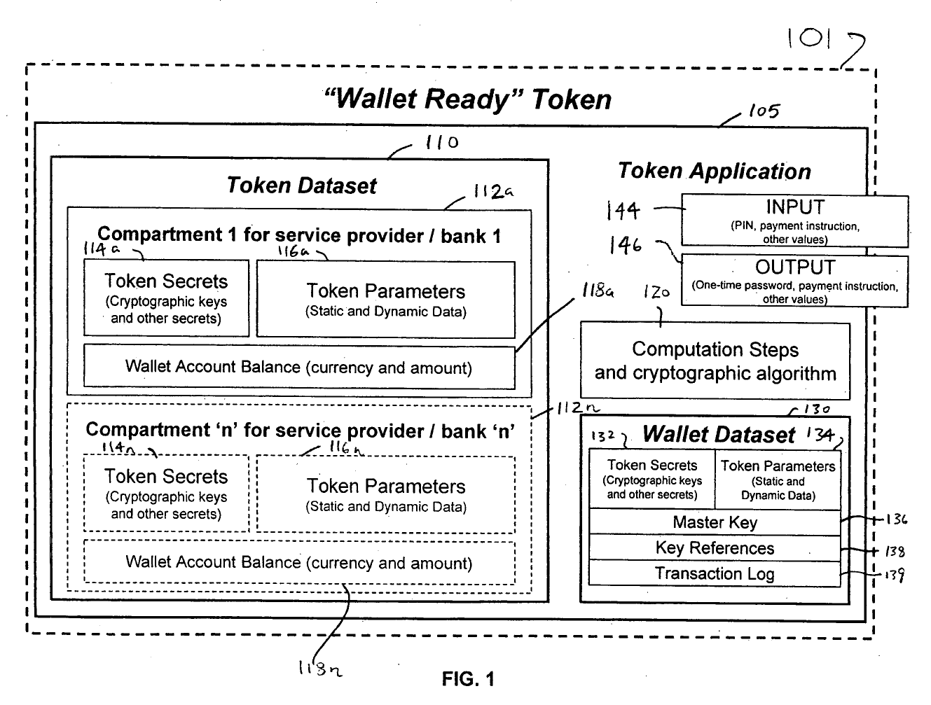

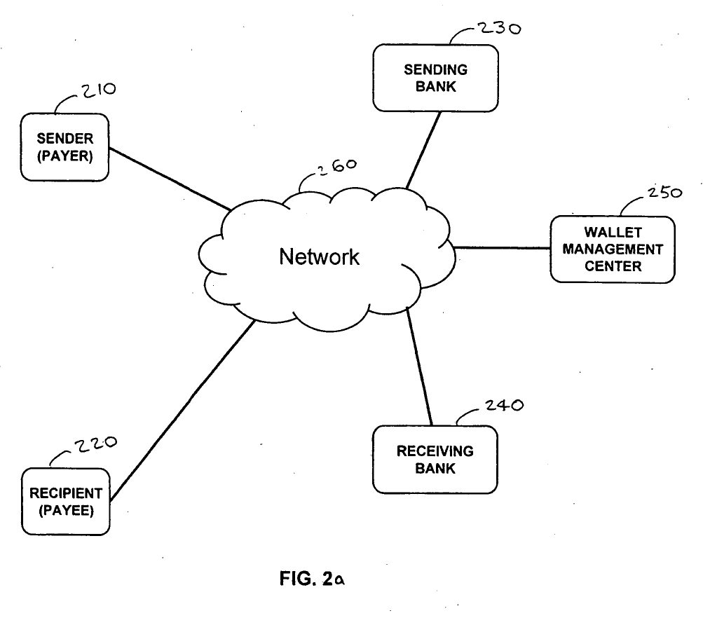

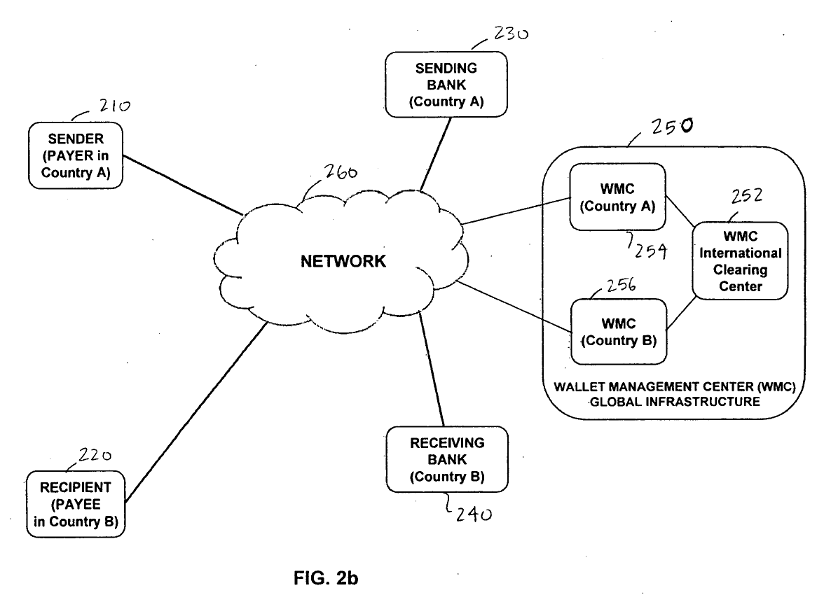

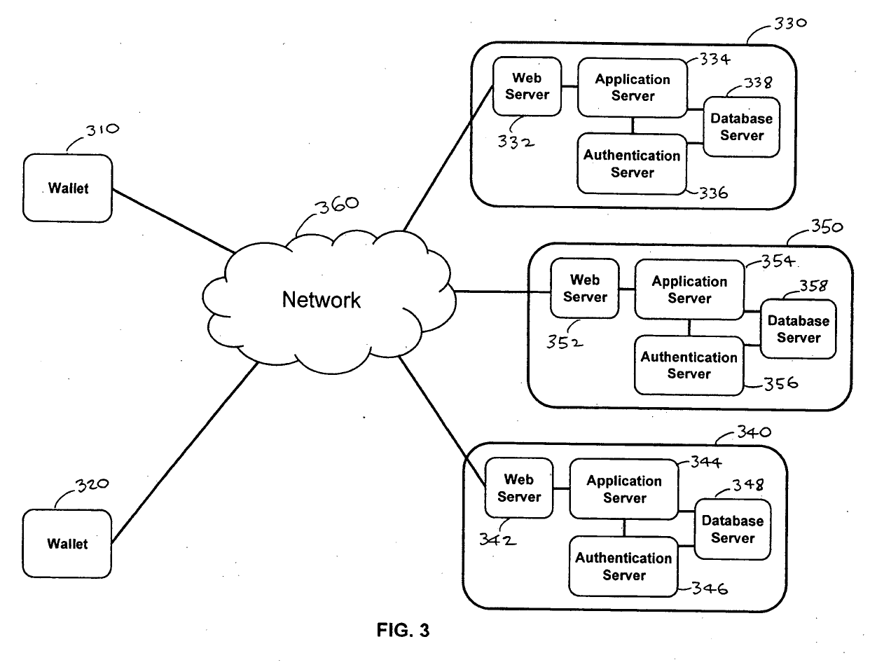

Figure (FIG.) 1 illustrates one embodiment of the logical components of a token with installed wallet application (“wallet ready” token) executing on a device in accordance with the present invention. The wallet application is a software application (e.g., programmed in Java, Visual Basic, .NET, or the like) that is structured as described herein and downloadable from a computing system. In one embodiment, the wallet application is accessed once a wallet account has been established by a user. The accessed wallet application is preconfigured on a device or downloadable to a device from a server at a wallet management center. Device examples are further described below in FIGS. 2 and 3.

The wallet application is installed on the device to create an “electronic wallet” (or “wallet”). The electronic wallet, i.e., the device with the installed wallet application, may be referenced generally as a token (or intelligent token), for example, a “wallet ready” token 101. The electronic wallet 101 includes a token application 105. The token application 105 includes a token dataset 110, a cryptographic mechanism 120, and a wallet dataset (transaction dataset) 130. The token dataset 110 includes one or more compartments 112a-n (generally 112). Each compartment 112 corresponds to a bank and an associated account balance 118 for the wallet account with that bank. Each compartment 112 also includes one or more token secrets 114 and one or more token parameters 116.

The wallet dataset 130 includes one or more token secrets 132, one or more token parameters 134, a master key 136, one or more key references 138 and a transaction log 139. The master key 136 is downloaded with the wallet application and is used to derive the actual keys using one or more key references 138. The key references 138 are downloaded by the wallet application from time to time. The key reference provides a reference to the actual key. The master key 136 and a key reference 138 are used to generate an encryption (or decryption) key using an encryption standard identified through the cryptographic mechanism 120. For example, a 128 or 192 bit encryption key may be derived from a 3DES encryption algorithm using the 128 or 192 bit master key and a unique key reference. A wallet encryption key is used for encrypting/signing/endorsing a payment instruction and a wallet decryption key is used by the wallet to authenticate responses from the wallet management center (not shown).

Note that generally token secrets 114, 132 include, for example, cryptographic keys, random numbers, control vectors and other secrets for computation and cryptographic operations. The token parameters 116, 134 refer to the control parameters, for example, encrypted PIN, a monotonically increasing or decreasing sequence number, optional transaction challenge code, transaction digests and usage statistics. Some of the token parameters 116, 134 are dynamic and are updated upon authentication operations. The token secrets 114 and token parameters 116 are used for payment authorization between the wallet and the wallet holder's bank (not shown). The token secrets 132 and token parameters 134 are used for authentication between the wallet holder (not shown) and the wallet management center.

The electronic wallet 101 also may include additional firmware or logic for executing functionality of the system and further described herein. In addition, the electronic wallet 101 includes an input interface 144 and an output interface 146, which may be configured to support local interfaces, for example of a screen and a keypad (or keyboard) of the device as well as a network interface of the device for communication with another electronic wallet and the wallet management center.

It is noted that the device alone may be referenced as a terminal (or an intelligent terminal). Examples of devices that may be configured to download and install a wallet application (for configuration as the electronic wallet 101) include a personal computer, a laptop computer, a desktop or workstation computer, a server computer (or system) a personal digital assistant (PDA) with a wired or wireless network interface card, or a smartphone or a mobile phone with a cellular access. The device can also be structured to be a large system such as a workstation or server computer. In general, it is noted that the device (or terminal) is structured to include a processor, memory, storage, network interfaces, and applicable operating system and other functional software (e.g., network drivers, communication protocols, etc.).

Operational Environment Overview

FIG. 2a illustrates one embodiment of an environment overview in which an electronic wallet may operate in accordance with the present invention. By way of example, an environment may include one or more senders (payer) 210, one or more recipients (payee) 220, one or more sending banks 230 (payer's bank), one or more receiving banks 240 (payee's bank) and a wallet management center (transaction management center) 250. Each sender 210 and each recipient 220 has an electronic wallet, for example, an electronic wallet 101 configured as described in FIG. 1. Each of these constituents of the system may be connected by one or more networks 260. The one or more networks 260 may be wired or wireless and may be a data network, voice network, or combination thereof.

Generally, the disclosed embodiments describe a system and a method for a sender 210 to generate a payment instruction from its electronic wallet (e.g., electronic wallet 101) to directly pay a recipient 220 through a network 260. The transaction may be conducted similar to a transaction as though the sender 210 was paying using a cash currency. The recipient 220 received the payment instruction at its electronic wallet (e.g., electronic wallet 101), and submits the payment instruction to the wallet management center 250 for authentication and payment clearance. The wallet management center 250 receives the payment instruction from the recipient 220, authenticates the transaction as further described herein. The wallet management center 250 then submits the payment instruction to the sending bank 230 and receiving bank 240 for payment clearing.

It is noted that the one or more senders 210 and the one or more recipients 220 can be individual persons or business entities and they may use different devices to hold their electronic wallets. For example, they may use mobile phones or computer servers as tokens to hold their respective electronic wallets. In one embodiment, the sender 210 may be a consumer and the recipient 220 may be a merchant. The payment transaction may be a result of an online commerce transaction or a brick and mortar commerce transaction (e.g., a retail or service sale). In another embodiment, the payment transaction also may be used for a direct person-to-person money transfer between the sender 210 and the recipient 220 that are engaging in a transaction.

There are one or more sending banks 230 corresponding to one or more banks with which one or more senders 210 have wallet accounts. There are one or more receiving banks 240 corresponding to one or more banks with which one or more recipients 220 have wallet accounts. A sender 210 and a recipient 220 may use the same bank (i.e., the sending bank 230 is also the receiving bank 240) or different banks.

The wallet management center 250 is configured to offload wallet management, for example, issuance or revocation of an electronic wallet (e.g., electronic wallet 101) from a sending bank 230 or a receiving bank 240. The wallet management center 250 also is configured to synchronize the electronic wallets with the wallet accounts in the sending banks 230 for senders 210 and the receiving banks 240 for recipients 220. In one embodiment, the wallet management center 250 is configured to serve as a wallet payment clearing house. It authenticates a payment instruction between the sender 210 and the recipient 220. The sending bank 230 and the receiving bank 240 is responsible for actual payment processing based on the authentic payment instructions submitted by the wallet management center 250 on behalf of the sender 210 and the recipient 220.

FIG. 2b illustrates another embodiment of an environment overview in which an electronic wallet may operate in accordance with the present invention. This example embodiment illustrates a configuration that is flexible to accommodate differing policies among financial institutions partaking in a system (or process) in accordance with the present invention. In this example embodiment, the wallet management center 250 is illustrated within a global infrastructure consisting of an international wallet management clearing center 252 and a local wallet management center 254, 256 in each country.

As described above, when the sending bank 230 and the receiving bank 240 are in the same country, a payment transaction between the sender and the recipient is handled by the local wallet management center 250. However, when the sending bank 230 and the receiving bank 240 are in different countries (or jurisdictions) (e.g., countries A and B), banking policies may differ per jurisdiction, yet the payment instruction from the sender in country A can be sent directly to the recipient in country B.

In particular, the recipient 240 transmits a request to the local wallet management center 256 in country B to authenticate the payment instruction. Through the wallet management center international clearing center 252, the local wallet management center 256 in country B will work with the local wallet management center 254 in country A to authenticate the sender 230 and the recipient 240. Once authenticated, the local wallet management center 256 in country B transmits a signal that advises the recipient 240 that the payment instruction is authentic and the local wallet management center 254 in country A transmits a request to the sending bank 230 to verify the payment instruction. The sending bank 230 in country A verifies the one-time authorization code in the payment instruction.

If there is a successful verification, the sending bank 230 debits the electronic wallet account of the sender for the payment amount and advise the local wallet management center 254 in country A. Through the wallet management center international clearing center 252, the local wallet management center 254 in country A will advise the local wallet management center 256 in country B to inform the receiving bank 240 to credit the electronic wallet account of the recipient for the payment amount accordingly. For enhanced privacy and security, there is no need to pass user profile information across jurisdictions, as the local wallet management center 254, 256 in different countries will work with each other through the wallet management center international clearing center 252. Thus, the wallet management center international clearing center 252 and the local wallet management centers 254, 256 in various countries beneficially form a unified global infrastructure and work together functionally as a single (logical) wallet management center.

Electronic Wallet Management System Overview

Referring now to FIG. 3, it illustrates one embodiment of an electronic wallet management system in accordance with the present invention. The figure illustrates one embodiment for communications coupling (e.g., connectivity) between an electronic wallet 310 of the sender 210, and electronic wallet 320 of the recipient 220, a sending bank 330, a receiving bank 340, and a wallet management center 350. These parties are communicatively coupled through one or more networks 360. Each electronic wallet 310, 320 includes the functional aspects of the electronic wallet 101 described in FIG. 1. The wallet management center 350 includes the functional aspects of the wallet management center 250 described in FIG. 2.

For ease of discussion, the sender 210 refers to a user who is using the electronic wallet 310 for sending a payment instruction. The recipient 220 refers to a user who is using the electronic wallet 320 for receiving the payment instruction. Thus, depending on the role that the user takes for a particular transaction, a user's electronic wallet can be configured as both a sender electronic wallet 310 and a recipient electronic wallet 320 at any point in time within the same or separate transactions.

Each electronic wallet 310, 320 is a computing device equipped and configured to communicate with other electronic wallets and the wallet management center 350 through the networks 360. The electronic wallet 310, 320 may be a standalone separate physical device dedicated to running the wallet ready token application or applet running on a separate standalone physical device (e.g., a sub-notebook or laptop computer, a desktop or workstation computer, a server computer (or system), a mobile phone, smartphone, or a personal digital assistant). It is noted that in general, the physical configuration and communication capabilities of each wallet 310, 320 is similar to the electronic wallet 101 described in FIGS. 1 and 2.

The electronic wallet 310, 320 is a security mechanism that computes one-time passwords or digital signatures, derives encryption keys, sends, receives, encodes and decodes payment instructions. As noted with the electronic wallet 101, the electronic wallet 310, 320 includes a token dataset having one or more compartments corresponding to one or more wallet accounts as a sending or receiving bank. As previously noted, each compartment holds token secrets and parameters. The token secrets refer to cryptographic keys, random numbers, control vectors and other secrets for computation and cryptographic operations by the wallet 310, 320 and by the authentication servers 336 of the sending bank 330 and the authentication server 346 of the receiving bank 340.

In addition, as described previously, the electronic wallet 310, 320 also contains a wallet dataset that includes token secrets and parameters, master key, key reference and transaction log for computation and cryptographic operations by the wallet 310, 320 itself and the authentication server 356 of the wallet management center 350. Token parameters refer to control parameters such as encrypted PIN, a monotonically increasing or decreasing sequence number, and usage statistics. It is noted that some token parameters are configured to be dynamic and they will be updated upon authentication operations.

In one embodiment, the sending bank 330 is structured to include a web server 332, an application server 334, an authentication server 336, and a database server 338. The web server 332 communicatively couples the network 360 and the application server 334. In addition, application server 334 communicatively couples with the authentication server 336 and the database server 338. The authentication server 336 communicatively couples the database server 338.

The web server 332 provides a front end into the sending bank 330 and functions as a communications gateway into the sending bank 330. It is noted that the web server 332 is not limited to an Internet web server, but rather can be any communication gateway that appropriately interfaces the networks 360, e.g., a corporate virtual private network front end or a cell phone system communication front end. For ease of discussion, this front end will be referenced as a web server 332, although the principles disclosed are applicable to a broader array of communication gateways. The web server 332 communicatively couples the application server 334 in the sending bank 330.

The application server 334 is configured to serve requests from the wallet management center 350. The authentication server 336 is configured to authenticate the authorization codes originated by the sending electronic wallet 310 and to mutually authenticate communication with the wallet management center 350. The database 338 is configured to store user profiles of the sender 210, an account balance and transaction log of the wallet account of the sender 210, and encrypted token secrets and token parameters of the corresponding bank compartment of the electronic wallet 310. In addition, the database 338 is configured to store inter-bank validation tables, which are used for communications between banks. In one embodiment, the inter-bank validation tables may sometime be referred to as essential inter-bank validation tables. The database 338 also stores mutual authentication secrets for establishing secure communication channel between itself (the sending bank 330) and the wallet management center 350.

The sending bank 330 system can be configured to operate through one or more conventional computing systems having a processor, memory, storage, network interfaces, peripherals, and applicable operating system and other functional software (e.g. network drivers, communication protocols, etc.). In addition, it is noted that the servers 332, 334, 336 and 338 are logically configured to function together and can be configured to reside on one physical system or across multiple physical systems.

Similar to the sending bank 330, the receiving bank 340 is structured to include a web server 342, an application server 344, an authentication server 346, and a database server 348. The web server 342 communicatively couples the networks 360 and the application server 344. The application server 344 communicatively couples with the authentication server 346 and the database server 348. The authentication server 346 communicatively couples the database server 348.

The web server 342 is a front end into the receiving bank 340 and functions as a communications gateway into the receiving bank 340. Similar to the web server 332 of the sending back 330, the web server 342 of the receiving bank 340 is not limited to an Internet web server, but rather can be any communication gateway that appropriately interfaces the networks 360, e.g., a corporate virtual private network front end or a cell phone system communication front end. Again, for ease of discussion, this front end will be referenced as a web server 342, although the principles disclosed are applicable to a broader array of communication gateways.

The application server 344 is configured to serve requests from the wallet management center 350. The authentication server 346 is configured to mutually authenticate communications with the wallet management center 350. In addition to the essential inter-bank validation tables, the database 348 is configured to hold user profiles of the recipient 220, account balance and transaction log of the wallet account of the recipient 220 and encrypted token secrets and token parameters of the corresponding bank compartment of the wallet 320. The database 348 also stores mutual authentication secrets for establishing secure communication channel between itself (the receiving bank 340) and the wallet management center 350.

Like the sending bank 330, the receiving bank 340 system can be configured on one or more conventional computing systems having a processor, memory, storage, network interfaces, peripherals, and applicable operating system and other functional software (e.g. network drivers, communication protocols, etc.). In addition, it is noted that the servers 342, 344, 346 and 348 are logically configured to function together and can be configured to reside on one physical system or across multiple physical systems.

A bank can be both a sending bank 330 and a receiving bank 340 depending on the role for a payment transaction received by it. Within one transaction the bank can be either a sending bank 330 or a receiving bank 340 or it can be both in instances in which the sender 210 and the recipient 220 use the same bank for their respective electronic wallets 310, 320.

Similar to the banks 330, 340, the wallet management center is structured to include a web server 352, an application server 354, an authentication server 356, and a. database server 358. The web server 352 communicatively couples the networks 360 and the application server 354. The application server 354 communicatively couples with the authentication server 356 and the database server 358. The authentication server communicatively 356 couples the database server 358.

The web server 352 is a front end into the wallet management center 350 and functions as a communications gateway into it. Similar to the web servers 332, 342 of the banks 330, 340, the web server 352 of the wallet management center 350 is not limited to an Internet web server, but rather can be any communication gateway that appropriately interfaces the networks 360, e.g., a corporate virtual private network front end or a cell phone system communication front end. Again, for ease of discussion, this front end will be referenced as a web server 352, although the principles disclosed are applicable to a broader array of communication gateways.

The application server 354 is configured to send requests to the banks 330 and 340 and to authenticate and decrypt the payment instructions originated from the electronic wallets 310 and 320. The authentication server 356 is configured to mutually authenticate the wallets 310, 320 and the wallet management center 350 based on payment instruction that has been encrypted/signed by the wallet 310 and encrypted/endorsed by the wallet 320. The authentication server 356 also is configured to mutually authenticate communication with the sending bank 330 and the receiving bank 340. The database 358 is configured to store user profiles of the sender 210 and the recipient 220, account balances and transaction logs of the electronic wallets 310, 320, encrypted wallet master keys, key references and encrypted token secrets and token parameters of the wallet datasets of the wallets 310, 320 and mapping tables of wallet account pointers and actual bank IDs (or routing numbers) and wallet account numbers of the corresponding wallets 310, 320.

Like the banks 330, 340, the wallet management center 350 system can be configured on one or more conventional computing systems having a processor, memory, storage, network interfaces, peripherals, and applicable operating system and other functional software (e.g., network drivers, communication protocols, etc.). In addition, it is noted that the servers 352, 354, 356 and 358 are logically configured to function together and can be configured to reside on one physical system or across multiple physical systems.

The wallet management system 350 beneficially offloads the sending bank 330 and the receiving bank 340 from issuance and revocation of an electronic wallet. In addition, the wallet management system 350 is beneficially configured to synchronize wallet account balances in sending bank 330 and receiving bank 340 corresponding with the respective sender electronic wallet 310 and the recipient electronic wallet 320. Moreover, the sending bank 330 and receiving bank 340 do not need to communicate directly with their respective corresponding electronic wallets 310, 320, thereby reducing processing and management overhead, while maintaining banking system integrity.

Generally, in one embodiment the system and method enable the sender 210 and the recipient 220 to each install their respective electronic wallet 310 and 320 once each opens an electronic wallet accounts with their banks (i.e., the sender 210 with their sending banks 330 and the recipient with their receiving bank 340). When a wallet 310, 320 is first installed, it contains a unique wallet dataset that includes a wallet master key and a set of token secrets and parameters as previously described. It also has memory space to hold current key references and recent transaction log records.

In advance of preparing and transmitting a payment instruction, the sender 210 loads a range (one or more) of key references (previously described) from the wallet management system 350 into its electronic wallet 310. Each key reference is used once with each transaction that is processed and thereafter discarded. In one embodiment, the sender 210 also should have a sufficient balance amount in its electronic wallet banking account of its sending bank 330. In addition, this balance preferably is synchronized with the electronic wallet 310. In alternative embodiments, the electronic wallet 310 can be structured to provide mechanisms to account for insufficient funds, while maintaining cash-like liquidity. For example, the electronic wallet 310 may be configured to include overdraft protection, linking to other accounts as the sending bank 210 to cover the insufficient funds, or access to a line of credit account.

As would be done in a conventional cash transaction, in one embodiment the sender 210 directly pays the recipient 220 by using the electronic wallet 310 to issue a payment instruction through the network 360. The recipient 220 determines if it can accept the payment with the amount of the payment instruction shown on its wallet 320. Once accepted by the recipient 220, the wallet 320 sends (or transmits) the payment instruction to the wallet management center 350 for authentication.

If there is a successful authentication of the payment instruction, the wallet management center 350 advises the recipient 220 by returning a reply to the wallet 320 if the payment instruction is deemed authentic. The wallet management center 350 requests the sending bank 330 to authorize the payment instruction that contains a one-time payment authorization code from the wallet 310. If there is a successful verification of the authorization code, the sending bank 330 authorizes and executes the payment instruction to debit the wallet account of the sender 210. The wallet management center 350 advises the receiving bank 340 to credit the wallet account of the recipient 220.

It is noted that in one embodiment, a “direct payment” may refer to (1) an ability of the sender to issue a payment instruction to the recipient without a preceding “store and forward” operation by an intermediary and (2) a direct authorization of the payment instruction by the sending bank. It is noted payment methods such as stored-value cards, checks, and debit card are classified as direct payment.

Example Process Using an Electronic Wallet Management System

The principles disclosed herein can be further described through additional examples for various processes involving the electronic wallet. For example, one process is wallet preparation, which includes obtaining key references for encryption of payment instructions. Another process is for the electronic wallet to send and receive encrypted payment instructions. Yet another process is directed to authentication of payment instructions. There is a process for payment authorization by banks. There also is a process for online enquiries by users using their electronic wallets.

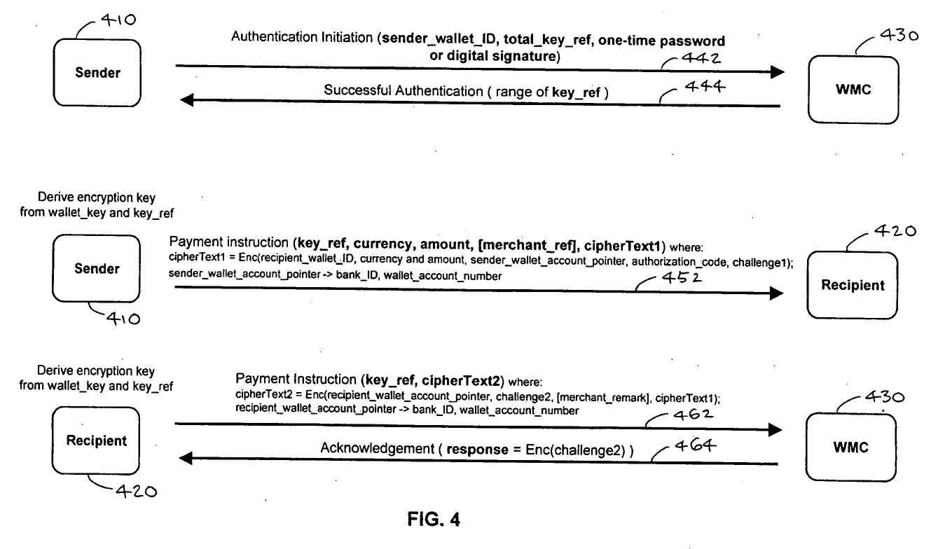

These additional examples are further reviewed in FIGS. 4 through 6. In each figure there is a sender 410, a recipient 420, a wallet management center 430, a sending bank 510 and a receiving bank 520. The sender 410 is functionally similar to the sender 210, the recipient 420 is functionally similar to the recipient 220, the sending bank 510 is functionally similar to the sending bank 230, the receiving bank 520 is functionally similar to the receiving bank 240 and the wallet management center 430 is functionally similar to the wallet management center 250. In addition, communication between the sender, the recipient, the sending bank, the receiving bank and the wallet management center is through one or more networks, for example, a network functionally similar to the network 260.

Once again, it is noted that there may be one or more senders, one or more recipients, one or more sending banks and one or more receiving banks but for ease of understanding only one is described for each. In addition, as previously noted, a user can be a sender or a recipient and the user can have both the roles, depending on the payment transaction. Similarly, a bank can be either or both a sending bank and a receiving bank, depending on the payment transaction. For ease of understanding, the examples in FIGS. 4 through 6 are given in a context of a specific role for each. In addition, reference to the electronic components may be made with reference to the components of the electronic wallet 101 described with respect to FIG. 1.

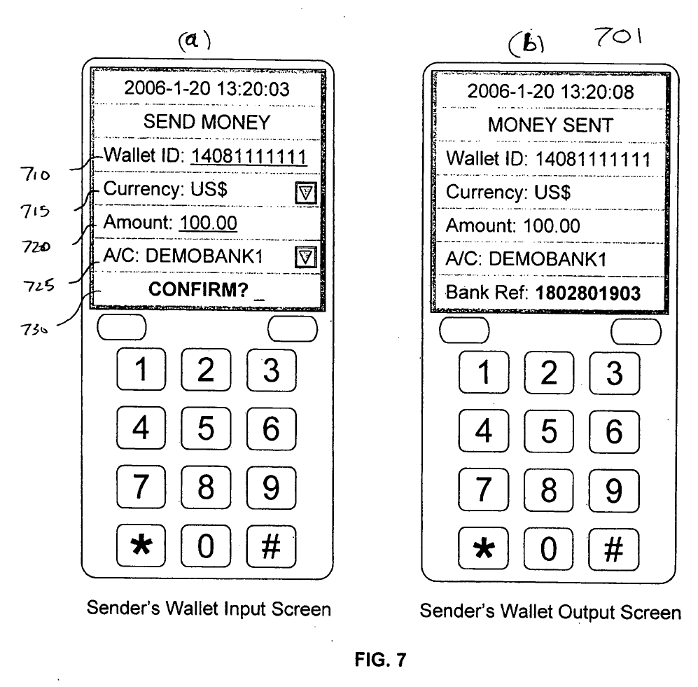

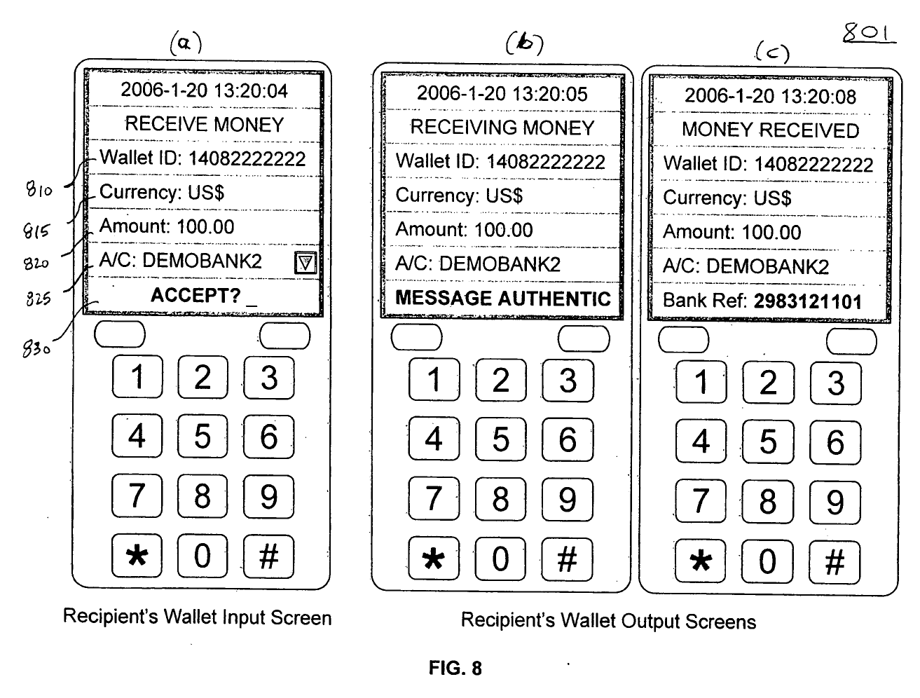

In describing the example processes illustrated in FIGS. 4 through 6, reference will also be made to FIGS. 7 and 8. FIG. 7 illustrates sample screens of the sender electronic wallet and FIG. 8 illustrates sample screens for the recipient electronic wallet. The sample screens illustrate a graphical display of information on the device portion of the electronic wallet.

Referring first to FIG. 4, it illustrates one embodiment of a process for wallet preparation and direct payment from a sender 410 to a recipient 420 in accordance with the present invention. The example illustrated describes preparing the electronic wallet of the sender 410 for use in transactions, for example, with the recipient 420. It is understood that the recipient 420 would have prepared in advance its electronic wallet in a similar manner.

As previously noted, one logical component of the electronic wallet is a key reference (e.g., key reference 138) that is a random value for encryption key derivation. Encryption and decryption keys are derived by using the cryptography mechanism (e.g., cryptographic mechanism 120) to encrypt the key reference using the wallet master key (e.g., wallet master key 136). The encryption key is then used to encrypt a payment instruction from the wallet and a decryption key is then used to decrypt a response from the wallet management center 430. The encryption key never leaves the perimeter of the wallet. The wallet management center has maintained a database of wallet master keys in encrypted form.

Note that a wallet has no key references when it is first installed or when all the key references are used. The key references are obtained from the wallet management center 430, which only is able to derive compatible encryption and decryption keys using the corresponding wallet master key and the key references of the sender 410 for a corresponding payment instruction. To obtain key references, the sender 410 transmits 442 to the wallet management center 430 an authentication request containing the sender wallet identifier (ID), the total number of key references required and a one-time password.

The one-time password is generated based on one or more token secrets (e.g., master token secrets 132) and token parameters (e.g., token parameters 138) of the wallet dataset in the electronic wallet of the sender 410. A digital signature may be used instead of a one-time password in some instances, for example, if the electronic wallet is a computer server.

The wallet management center 430 maintains encrypted token secrets and parameters that are synchronized with the wallet dataset of the electronic wallet of the sender 410. Using this stored information the wallet management center 430 authenticates (or verifies) the one-time password received from the sender 410 in the authentication request. An example of an authentication system that the wallet management center 430 is configured to include is described in U.S. patent application Ser. No.______, filed Mar. ______, 2006 (same day as present application), titled “Single One-Time Password Token with Single PIN For Access To Multiple Providers,” by the Eric Chun Wah Law and Lap Man Yam, the contents of which is incorporated by reference.

If authentication is successful, the wallet management center 430 transmits 444 a response of a successful authentication with a range (one or more) of key references 138. In one embodiment, to conserve network bandwidth with respect to information transmission, the range of key references is represented by a starting key reference number and the total number of key references. The electronic wallet of the sender 410 is now ready to engage in transactions.

To issue a payment instruction, the sender 410 inputs data for the transaction into its electronic wallet. FIG. 7(a) illustrates one embodiment of an input screen presented on the electronic wallet of the sender 410. The input data may include a wallet identification (ID) 710 of the recipient, selects a currency 715 (if multiple currencies are supported), selects an amount 720 for the transfer, and selects a wallet account or bank 725 from where to transfer the money. Optionally the sender 410 also may enter a merchant reference number, e.g., if the recipient 420 requires it.

It is noted that in alternative embodiments, some or all of the data may be entered for the sender 410 by the recipient 420 so that the user need only confirm the data or enter in fewer information. For example, the recipient point of sales mechanism or electronic wallet may transmit (e.g., through radio frequency connection using Near Field Communication (NFC) technology) to the electronic wallet of the sender the recipient wallet ID 710, the currency 715, and the amount 720. At this stage the sender 410 would enter in its wallet account or bank account 725.

With the data now entered and ready for transmission, the sender can select to confirm 730 the transaction. Once confirmed 730, the electronic wallet of the sender 410 selects the next available key reference. This key reference is used with the electronic wallet master key to derive an encryption key. Using the derived encryption key, the electronic wallet of the sender 410 generates a first ciphertext (or cipher text) by encrypting the recipient wallet ID, the currency (optional), the transfer amount (payment amount), the sender electronic account wallet account number, a payment authorization code and a random first challenge.

The payment authorization code is a one-time password derived from a token dataset of a compartment of the electronic wallet of the sender corresponding to the sending bank to be used by the sender 410 for the transaction. The challenge code is randomly generated by the electronic wallet of the sender 410. The challenge code will be used by the sender electronic wallet to authenticate subsequent responses from the wallet management center 430.

It is noted that in one embodiment, a pointer to the sender electronic wallet account may be used instead of the actual bank ID (or bank “routing code”) and bank wallet account number. This configuration provides additional privacy and security and increase network efficiency by reducing the amount of data necessary for transmission.

Using the first ciphertext, along with a clear form (e.g., clear text) of the key reference, currency, amount and the optional merchant reference, the electronic wallet of the sender 410 constructs a payment instruction that may also be optionally encrypted (e.g., using keys, separate from the ciphertext as described below, conventionaly available for use between the sender and recipient such as public key cryptography). The electronic wallet of the sender 410 then transmits (or sends) 452 the payment instruction to the recipient 420.

The electronic wallet of the recipient 420 receives the payment instruction from the electronic wallet of the sender 410. FIG. 8(a) illustrates one embodiment of a screen that may be presented to the recipient 420. In particular, the electronic wallet of the recipient 420 displays a wallet ID 810 of the sender 410, a currency 815, and a transfer amount 815. The recipient 420 may select a receiving bank 825 for the incoming payment instruction and accept 830 the transaction.

Next, the electronic wallet of the recipient 420 derives an encryption key using it's (the recipient 420) wallet master key and the specified key reference of the incoming payment instruction (the key reference from the sender 410). The electronic wallet of the recipient 420 uses the encryption key to generate a second ciphertext by encrypting the recipient wallet account pointer, a random second challenge code and the first ciphertext. Encrypting the first ciphertext again results in a second level encryption of it. This two level payment instruction may be encrypted and is constructed by adding a clear form of the key reference of the sender 410 with the second ciphertext. The electronic wallet transmits 462 the two-level payment instruction to the wallet management center 430 for authentication. When the payment instruction is transmitted by the recipient 420, the network (operator) inserts or adds in the recipient elecronic wallet (or wallet) ID (e.g., using a caller identification (ID) type function of the network), which the wallet management center 430 uses as described below.

It is noted that optionally, if the recipient 420 is a merchant with computer server running a wallet application, the recipient 420 may add a merchant remark for encryption into the second ciphertext. Examples of a merchant remark may include the merchant short name and transaction reference number or other voucher number that the merchant may later use for reconciliation or audit purposes.

The wallet management center 430 derives the second level encryption key from the wallet master key of the recipient 420 and the given key reference from the sender 410. The wallet management center 430 also derives the first level encryption key from the wallet master key of the sender 410 and the given key reference from the sender 410. Upon successful decryption, the wallet management center 430 validates the recipient wallet ID. Specifically, the wallet management center 430 compares the recipient wallet ID from the first level ciphertext with the recipient wallet ID of the incoming message (which came with the second level (two-level) encrypted payment instruction) from the recipient (e.g., as the caller ID). If the decrypted value matches with the given value, authentication of sender and recipient is successful.

The wallet management center 430 also obtains the sender wallet ID from the database (e.g., database 358) according to the key reference from the sender 410. It is noted that in one embodiment only the genuine sender and recipient have the key reference and the genuine master keys to derive the correct encryption keys. However, the wallet management center 430 has the same master keys and key reference (previously stored in the database) to derive the decryption keys. If the payment instruction was not encrypted with the correct encryption keys by either the sender or the recipient, the decrypted data would not reveal the correct value of the recipient wallet ID, and thus, verification of the critical parameter value would fail. Further, it is noted that for the sender and the recipient to authenticate the wallet management center, the first and second challenge codes are used correspondingly.

In addition, because the wallet management center 430 receives the wallet account pointer for the sender 410 and the wallet account pointer for the recipient 429, it also is configured to retrieve the sending bank ID, the receiving bank ID, the sending bank wallet account number and the receiving bank wallet account number from its database.

Upon successful authentication, the wallet management center 430 immediately transmits 464 to the electronic wallet of the recipient 420 a response that includes a decrypted and re-encrypted second challenge code. This refers to the process that the second challenge code is decrypted from the second cipher text and encrypted again in the response message. The electronic wallet of the recipient 420 displays a message to advise that payment instruction is authentic. FIG. 8(b) illustrates an example screen that may be displayed on the device portion of the electronic wallet. The wallet of the recipient 420 updates its transaction log (e.g., transaction log 139) in its wallet dataset accordingly. If the recipient 420 is a merchant, an automated process communicatively couples the electronic wallet portion handling the transaction with a point of sales system to update data records corresponding to the sales transaction (e.g., inventory information, etc.).

It is noted that the authenticity of the payment instruction is verified using the wallet master keys of the sender 410 and the recipient 420. Correspondingly, the wallet management center 430 records this as a proof of non-repudiation of the payment transaction between the sender 410 and the recipient 420.

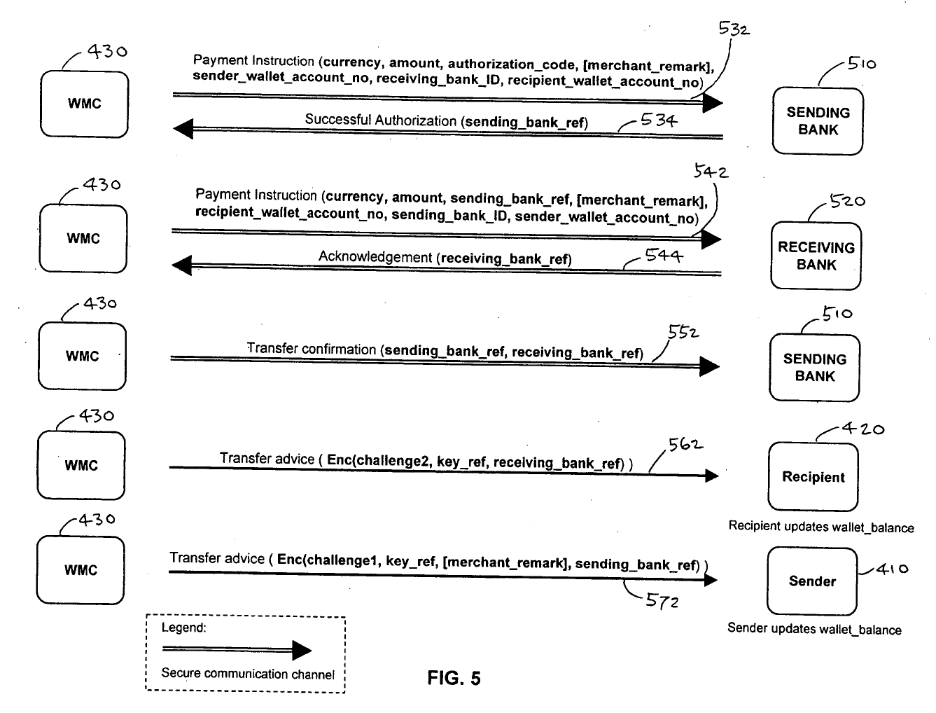

Turning now to FIG. 5, it illustrates one embodiment of a process for clearing a payment instruction with a sending bank 510 and a receiving bank 520 in accordance with the present invention. In initiating this process, the wallet management center 430 transmits 532 to the sending bank 510 a payment instruction comprising the payment currency, transfer amount, payment authorization code, wallet account number of the sender 410, receiving bank ID and the electronic wallet account number of the recipient 420. The wallet account pointers provided from the electronic wallet of the sender 410 and the recipient 420 to the wallet management center 430 is used to identify the appropriate sending bank 510 and receiving bank 520 and accounts at each bank 510, 520. It is noted that in one embodiment the communications between the wallet management center 430 and the sending bank 510 are along a secured (e.g., encrypted) communication channel with mutual authentication before the communication session is established.

Once the sending bank 510 receives the payment information from the wallet management center 430, it verifies the payment authorization code using the corresponding token secrets and parameters of the sender 410. Upon successful verification, the sending bank 510 transmits 534 to the wallet management center 430 a sending bank reference number advising of the authorization and execution of the payment instruction and debiting of the given transfer amount to the electronic wallet account of the sender 410. The sending bank 510 records the receiving bank ID and recipient wallet account number and optionally the merchant remark, if available, into a transaction log. The transaction log may be used for reconciliation, user enquiries such as transaction history and monthly statement, or the like.

The wallet management center 430 also transmits 542 to the receiving bank 520 a payment instruction comprising the payment currency, transfer amount, electronic wallet account number for the recipient 420, sending bank ID and the electronic wallet account number of the sender 410. The wallet account pointers provided from the electronic wallet of the sender 410 and the recipient 420 to the wallet management center 430 is used to identify the appropriate sending bank 510 and receiving bank 520 and accounts at each bank 510, 520.

It is noted that in one embodiment communications between the wallet management center 430 and the receiving bank 520 are along a secured (e.g., encrypted) communication channel with mutual authentication before the communication session is established. In addition, note that while real-time processing is preferred, the transmissions between the wallet management center 430 and each of the sending bank 510 and the receiving bank 520 can occur in real-time and serial manner, or in batch transactions executed at one or more predetermined time periods according to preferences of individual banks 510, 520.

The receiving bank 520 transmits 544 to the wallet management center 430 a receiving bank reference number advising of the execution of the payment instruction and crediting of the given transfer amount to the electronic wallet account of the recipient 420. The receiving bank 520 records the sending bank ID and sender wallet account number and optionally the merchant remark, if available, into a transaction log that may be used for reconciliation, user enquiries such as transaction history and monthly statement, or the like.

To complete the payment clearing, the wallet management center 430 transmits 552 to the sending bank 510 the receiving bank reference number together with the sending bank reference number for purposes of cross referencing between the two entities 510, 520. Note that the process disclosed provides for a complete audit trail of the multi-party validated payment transaction between the sending bank 510, the receiving bank 520 and the wallet management center 430, thereby creating auditable transaction logs in all three parties and enhancing money traceability. This offers sufficient information for multi-lateral netting and subsequent inter-bank settlement between the sending bank 510 and the receiving bank 520 through existing inter-bank settlement infrastructure between them (510 and 520).

Next, the wallet management center 430 transmits 562 a notification to the electronic wallet of the recipient 420. The notification is an encrypted transfer advice comprised of the second challenge code, the key reference and the receiving bank reference number. The electronic wallet of the recipient 420 decrypts the transfer advice, verifies the second challenge code and displays the confirmation onto the device portion of electronic wallet of the recipient. FIG. 8(c) illustrates one example of a user interface screen displayed on the device portion of the electronic wallet of the recipient 420.

With the transaction confirmed, the electronic wallet of the recipient 420 updates its transaction log accordingly. In one embodiment, it the recipient 420 is a merchant, this process may be further automated, for example, communicatively coupling the electronic wallet of the recipient 420 with its accounting system to update its account receivable database.

The wallet management center 430 also transmits 572 a notification to the electronic wallet of the sender 410. This notification is an encrypted transfer advice comprised of the first challenge code, the key reference and the sending bank reference number. The wallet decrypts the transfer advice, verifies the first challenge code and displays the confirmation at the device corresponding to the electronic wallet for viewing by the sender 410. FIG. 7(b) illustrates one example of a user interface screen displayed on the device portion of the electronic wallet of the recipient 420. Accordingly, the electronic wallet of the sender 410 is configured to update the transaction log.

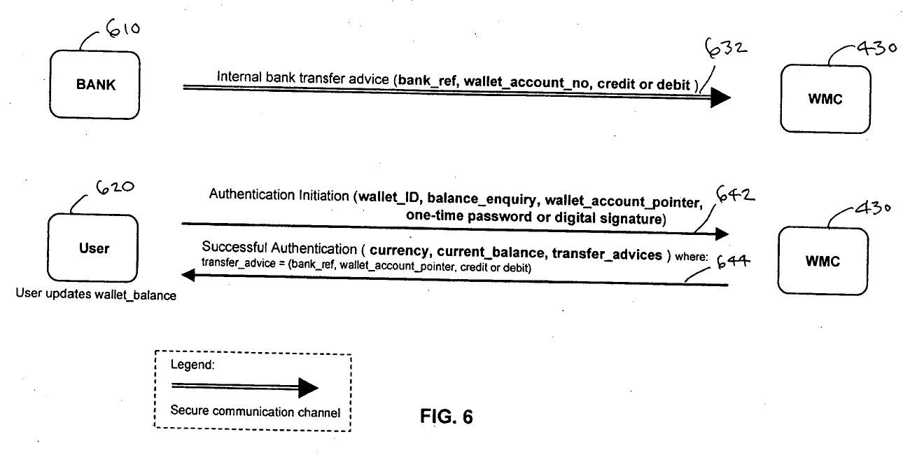

Turning to FIG. 6, it illustrates one embodiment of a process for synchronizing balances with the wallet management center after crediting or debiting electronic wallet accounts using conventional banking channels in accordance with the present invention. As previously referenced, a deposit and a withdrawal of money between a wallet account and other banking accounts (e.g., a savings account, a checking accounts a credit card account or a line of credit account) of a user can be carried out using existing banking channels. Examples of existing banking channels include over-the-counter service, automated teller machine (ATM), or Internet banking. In this example description, it is noted that a user 620 is a user having an activated electronic wallet, e.g., the electronic wallets previously described (e.g., 101), and that can be either a sender, e.g., sender 410, or a recipient, e.g., recipient 420.

In this process, a bank 610, e.g., the sending bank 510 or receiving bank 520, transmits 632 a notification to the wallet management center 430 about an internal bank transfer. The notification includes bank reference numbers, wallet account numbers and the credit or debit amounts corresponding to the account holder of the user 620. As noted previously, the wallet management center 430 and the bank 610 may communicate through a secured (e.g., encrypted) communication connection.

The user 620 may synchronize the balance of the electronic wallet with one's bank 610 by transmitting 642 an authentication initiation to the wallet management center 430. The authentication initiation includes the wallet ID, a balance enquiry request indicator, a wallet account pointer and a one-time password. The wallet management center 430 authenticates the one-time password, e.g., using the authentication system referenced previously. With successful authentication, the wallet management center 430 transmits 644 the updated bank wallet account balance information to the electronic wallet of the user 620. The wallet management center 430 also posts the saved transfer advices given earlier by the bank 610 to the electronic wallet of the user 620. Accordingly, the electronic wallet of the user 620 updates its transaction log.

An Example Transaction Lifecycle

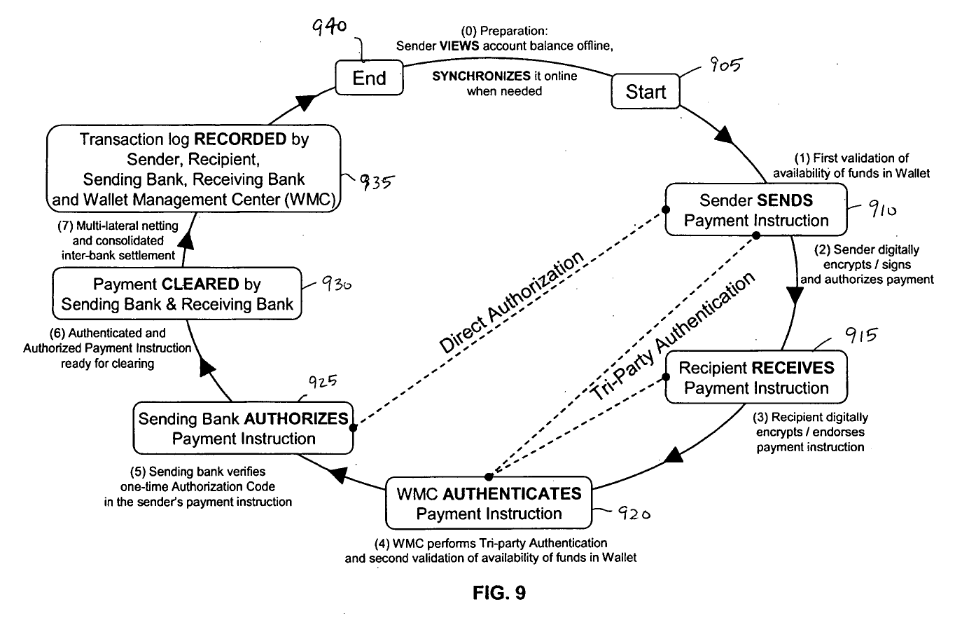

Referring now to FIG. 9, it illustrates one example embodiment of a transaction completed using an electronic wallet in accordance with the present invention. For ease of discussion, the process will be described with reference to the sender 410 and recipient 420, their respective banks 510, 520 and the wallet management center 430. The process starts 905 with the sender 410 electronic wallet being validated, e.g., by the sender 410, as having sufficient funds. If so, the sender 410 sends (or transmits) 910 a payment instruction to the recipient. As noted previously, the payment instruction is digitally encrypted, signed and authorized by the sender 410. A digital signature is achieved by encrypting a computed hash of the payment instruction. A payment authorization code is created by computing a one-time password (or digital signature if the wallet is a computer server) using the token secrets and parameters in the token compartment specific to the sending bank. The recipient 420 receives 915 the payment instruction. The recipient 420 also digitally encrypts and endorses it and transmits the now twice encrypted payment instruction to the wallet management center 430. Similarly, a digital endorsement is achieved by encrypting a computed hash of the payment instruction.

The wallet management center 430 authenticates the two-level encrypted payment instruction. In one embodiment, authentication includes performing a tri-party authentication of each party (i.e., the sender 410, the recipient 420, and the wallet management center 430) and identifying the appropriate sending bank 510 and receiving bank 520. The wallet management center 430 also performs another validation of the funds in the electronic wallet of the sender 420. It is noted that the wallet management center 430 would be configured to maintain up-to-date wallet account balance of the sender 410 with the sending bank 510.

Once tri-party authentication is successful, the wallet management center 430 transmits the payment instruction to the sending bank 510. The sending bank 510 receives the payment instruction and authorizes 925 it. In particular, the sending back 510 verifies the one-time authorization code in the sender's 410 payment instruction. This provides a direct authorization mechanism between the sender 410 and the sending bank 510 as the other parties of the transaction, including the wallet management center 430, do not have the information to perform this verification step.

Once the payment instruction is authorized by the sending bank 510, payment can be cleared 930 by the sending bank 510 and the receiving bank 520. Note that in one embodiment, the process of clearing the transaction (and appropriate subsequent inter-bank settlement between the banks 510, 520) is done directly between the banks 510, 520 without intervention by the wallet management center 430. With the transaction cleared, the sending bank 510 and the receiving bank 520 send appropriate confirmations (e.g., reference numbers and/or alphas) to the wallet management center 430, which transmits the confirmation to the sender 410 and the recipient 420. The account information and transaction logs of all parties 410, 420, 430, 510, 520 is updated/recorded 935 before the process ends.

The numerous embodiments and examples herein illustrate a number of advantages of the present invention. For example, because the electronic wallet account is part of the mainstream banking system, money is kept within the banking system for the users who have opened electronic wallet accounts. There is no need to transfer the money into another escrow or store the value in pre-paid cards. Thus, the user retains monetary liquidity.

Another advantage is trusted direct payment instructions from the sender to the recipient provided a sender has sufficient funds in its electronic wallet. Specifically, the sender electronic wallet balance is synchronized with the wallet management center and the authenticity of the payment instruction is verified by the wallet management center. Therefore, the authentic payment instruction can be trusted with high level of confidence. The recipient has the option to accept the payment, especially a small amount transaction, before the payment instruction is completely cleared with the sending and receiving banks. This configuration also provides a benefit of enhancing transaction speed.

Still another advantage is authenticity of the payment instruction serving as a proof of transaction non-repudiation. Further, a multi-party validated audit trail means transaction traceability. Both are helpful in maintaining confidence and integrity of the transaction and the underlying system configuration.

Yet another advantage is robust security. The account balance of an electronic wallet is determined by the available money in the corresponding wallet account in a bank. It is first validated by the wallet itself and subsequently re-validated by the wallet management center. Therefore, the risk associated with a pre-determined money balance is minimal. In addition, cryptographic processing as described herein segregates authentication risks. For example, decryption of the payment instruction can only be done by the wallet management center and verification of the authorization code can only be done by the sending bank.

Another advantage is flexibility of use of a direct payment method. The direct payment as described herein is functional in both online and brick and mortar physical commerce environments. For example, as low-cost proximity technology (e.g., Near Field Communication (NFC), WiFi, and Bluetooth) continues to gain widespread integration and acceptance the electronic wallet flexibility incorporates such technology. Thus, point of sales systems integrating such technology can interoperate with the electronic wallet through the proximity technology interface used by the point-of-sales terminal.

Still another advantage is the recipient may use a common intelligent token, for example, a personal computer, a mobile phone, a PDA or other portable device, having its electronic wallet from which payment can be accepted. The system is configured to be beneficially flexible to accommodate a wide array of transaction environments. For example, the electronic wallet can be configured within a mobile phone of an individual participating in a one-time transaction, e.g., a garage sale, or of an individual street merchant. Likewise, the system is flexible so that the wallet can be configured within a high performance computing system (e.g., servers) to handling large volume of payment transactions in real time or batch processing modes as may be present in large transaction environments (e.g., large retail operations).

Further, the features and advantages described in the specification provide a beneficial use to those making use of a system and a method as described in embodiments herein. For example, a user is provided mechanisms, e.g., by receiving and/or transmitting control signals and/or instructions, to control access to particular information as described herein. In addition, these benefits accrue regardless of whether all or portions of components, e.g., server systems, to support their functionality are located locally or remotely relative to the user.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for electronic wallet initiation, configuration, management, and operation through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A structure for secured communication, the structure comprising:
a token dataset including at least one compartment, each compartment corresponding to a financial institution account and configured to include a token secret, a token parameter, and an account balance, the token secret and the token parameter for use in authorizing a transaction with a financial institution; and
a transaction dataset configured to include a token secret and a token parameter corresponding to a transaction management system and configured to include a master key and at least one key reference, the master key and the at least one key reference for use in authentication with the transaction management system and for encrypting and decrypting communications with the transaction management system.

2. The structure of claim 1, further comprising at least one encryption mechanism configured to encrypt communications with the transaction management system.

3. The structure of claim 1, wherein the at least one key reference is received from the transaction management system.

4. The structure of claim 3, wherein the master key is configured to generate an encryption key using the at least one key reference, the encryption key for the communications with the transaction management system.

5. A method for facilitating an electronic payment between a sender and a recipient, the method comprising:
receiving a recipient identification from a network;
receiving from the recipient a key reference and a second level ciphertext, the second level ciphertext including a first level ciphertext, the first level ciphertext including a recipient identification from the sender;
decrypting, using the key reference and a master key for the recipient, the second level ciphertext;
decrypting, using the key reference and a master key for the sender, and the first level ciphertext to identify the recipient identification from the sender; and
verifying the recipient identification from the network matches the recipient identification from the sender to authenticate the sender and the recipient.

6. The method of claim 5, wherein the first level ciphertext further comprises a payment amount and an authorization code.

7. The method of claim 6, further comprising transmitting to a sending bank, in response to the sender and the recipient being authenticated, the payment amount and the authorization code from the decrypted first level ciphertext.

8. The method of claim 7, further comprising:
receiving from the sending bank an authorization including a transaction reference number, the transaction reference number corresponding to a debit from a sender electronic wallet account equal to the payment amount;
transmitting to a receiving bank the transaction reference number; and
receiving from the receiving bank an acknowledgement of the payment amount corresponding to a credit of the recipient electronic wallet account equal to the payment amount.

9. The method of claim 6, further comprising transmitting to the sender a confirmation of the payment amount transferred to a recipient account in a receiving bank.

10. The method of claim 6, further comprising transmitting to the recipient a confirmation of the payment amount transferred from a sender account in the sending bank.

11. The method of claim 6, further comprising authenticating simultaneously the sender and the recipient in response to receiving the instruction of sender payment.

12. The method of claim 6, wherein the first level ciphertext further comprises a first challenge code corresponding to the recipient.

13. The method of claim 6, wherein the second level ciphertext further comprises the recipient electronic wallet identification and a pointer to the sender electronic wallet account.

14. The method of claim 12, wherein the second level ciphertext further comprises a second challenge code corresponding to the sender.

15. The method of claim 5, wherein the recipient identification is an electronic wallet identification of the recipient.

16. In a transaction between a sender and a recipient, a method for accepting an electronic payment from the sender of the electronic payment, the method comprising:
receiving an electronic payment instruction from an electronic wallet of the sender, the electronic payment instruction including a key reference corresponding to the transaction, a payment amount, and a first ciphertext, the first ciphertext including an identification of an electronic wallet of the recipient and an authorization code;
encrypting the received electronic payment instruction to generate a second ciphertext, the second ciphertext including the first ciphertext;
transmitting the identification of the electronic wallet of the recipient and the second ciphertext to a wallet management center; and
receiving acknowledgement from the wallet management center of successful authenication of the sender and the recipient, the authentication through verification of the transmitted identification of the electronic wallet of the recipient and the identification of the electronic wallet of the recipient in the first ciphertext.

17. The method of claim 16, further comprising receiving a confirmation of a transfer of the payment amount from a sending bank to a receiving bank, the confirmation in response to the sending bank verifying the authorization code and debiting the payment amount from a payment account of the sender.

18. The method of claim 16, further comprising transmitting payment details to the electronic wallet of the sender, the payment details including the identification of an electronic wallet of the recipient.

19. The method of claim 18, wherein the payment details includes merchant reference information.

20. In a transaction between a sender and a recipient, a method for transmitting an electronic payment to a recipient of the electronic payment, the method comprising:
deriving an encryption key from a master key and a key reference within an electronic wallet of the sender;
generating a ciphertext from the encryption key, the ciphertext comprising an encryption of an electronic wallet identification of the recipient, a payment amount, and a pointer to a sender bank account; and
transmitting a electronic payment instruction to an electronic wallet of the recipient, the electronic payment instruction including the ciphertext, the key reference, and the payment amount.

21. The method of claim 20, wherein the ciphertext further comprises an encryption of a challenge code.

22. The method of claim 20, wherein the pointer to the sender bank account further comprises a bank identification of a sending bank and an electronic wallet account at the sending bank.

23. The method of claim 20, further comprising receiving from a wallet management center a transfer advise, the transfer advise comprising an encryption of the challenge code, the key reference, and a reference from a sending back.

24. A method of authorizing an electronic payment instruction between. a sender and a recipient, the method comprising:
receiving from a transaction management system an authenticated payment instruction authenticating the sender and the recipient to a transaction, the authenticated payment instruction originating from an original payment instruction decrypted by the transaction management system, the original payment instruction including a key reference from the sender and a first level ciphertext, the first level ciphertext comprising a pointer to a recipient electronic wallet account and a second level ciphertext, the second level ciphertext comprising a payment amount and an authorization code from the sender;
verifying the authorization code within the payment instruction decrypted by the transaction management system; and
approving, in response to the authorization code being verified, the payment amount specified in the electronic payment instruction.

25. The method of claim 24, wherein approving a payment amount further comprises approving the payment amount in response to a sender account having sufficient credit available.
